(19) United States
(12) Patent Application Publication
(10) Pub. No.: US 2025/0023717 A1
(43) Pub. Date: Jan. 16, 2025

(54) DISTRIBUTED RE-ENCRYPTION APPARATUS, CRYPTOGRAPHIC SYSTEM, DISTRIBUTED RE-ENCRYPTION METHOD, AND DISTRIBUTED RE-ENCRYPTION PROGRAM

(71) Applicant: NEC Corporation, Tokyo (JP)

(72) Inventors: Hikaru TSUCHIDA, Tokyo (JP); Takuya HAYASHI, Tokyo (JP); Toshiyuki ISSHIKI, Tokyo (JP); Kengo MORI, Tokyo (JP); Yukimasa SUGIZAKI, Tokyo (JP)

(73) Assignee: NEC Corporation, Tokyo (JP)

(21) Appl. No.: 18/765,390

(22) Filed: Jul. 8, 2024

(30) Foreign Application Priority Data
Jul. 12, 2023 (JP) 2023-114449

(51) Int. Cl. H04L 9/08; H04L 9/00

(52) U.S. Cl. CPC H04L 9/085; H04L 9/008; H04L 9/0861

(57) ABSTRACT

A distributed re-encryption apparatus comprises: a distributed re-encryption key storage part that stores shares obtained by secret-sharing a re-encryption key that re-encrypts a ciphertext into one encrypted with a different encryption key without decrypting the ciphertext; and a distributed re-encryption part that re-encrypts using the shares of the re-encryption key the ciphertext into one encrypted with a different encryption key without decrypting the ciphertext.

### REFERENCE TO RELATED APPLICATION

The present invention is based upon and claims the benefit of the priority of Japanese patent application No. 2023-114449 filed on Jul. 12, 2023, the disclosure of which is incorporated herein in its entirety by reference thereto.

### FIELD

The present invention relates to a distributed re-encryption apparatus, cryptographic system, distributed re-encryption method, distributed re-encryption program.

### BACKGROUND

Homomorphic encryption is known as a method that allows the value of plaintext to be manipulated by performing an operation on ciphertext without decrypting it. In particular, fully homomorphic encryption (FHE) is a scheme that supports manipulation relating to two types of operations-addition and multiplication. With general homomorphic encryption, an operation can be performed on ciphertext encrypted with the same key without decrypting it, however, an operation cannot be performed on ciphertext encrypted with different keys without decryption. Meanwhile, multi-key fully homomorphic encryption (multi-key FHE) has been developed to enable an operation between ciphertexts encrypted with different keys.
[NPL 1] YASUDA, Satoshi, et al., “Multi-key Homomorphic Proxy Re-Encryption,” In: International Conference on Information Security, Springer, Cham, 2018, pp. 328-346.

### SUMMARY

The disclosure of Non-Patent Literature cited above is incorporated herein in its entirety by reference thereto. The following analysis is given by the present inventors.

A problem with multi-key fully homomorphic encryption (multi-key FHE) is that, while it allows an operation between ciphertexts encrypted with different keys, the owners of the decryption keys associated with the keys involved in the computation must be online during decryption. To solve this problem, NPL 1 proposes a technique that re-encrypts a ciphertext into one encrypted using a receiver's encryption key without decrypting it.

The technique described in NPL 1, however, has a problem that, if the re-encryption key is leaked or the computation server colludes with the receiver, the user's decryption key before re-encryption may leak. For instance, a user i's decryption key may leak from a re-encryption key that re-encrypts using a receiver R's key a ciphertext encrypted with the user i's key.

In view of the problem above, it is an object of the present invention to provide a distributed re-encryption apparatus, cryptographic system, distributed re-encryption method, and distributed re-encryption program that contribute to preventing the leakage of a user's decryption key from a re-encryption key that re-encrypts a ciphertext so that it can be decrypted with a receiver's key.

According to a first aspect of the present invention, there is provided a distributed re-encryption apparatus comprising: a distributed re-encryption key storage part that stores shares obtained by secret-sharing a re-encryption key that re-encrypts a ciphertext into one encrypted with a different encryption key without decrypting the ciphertext; and a distributed re-encryption part that re-encrypts using the shares of the re-encryption key the ciphertext into one encrypted with a different encryption key without decrypting the ciphertext.

According to a second aspect of the present invention, there is provided a cryptographic system having: a plurality of the distributed re-encryption apparatuses described above; a plurality of key generation apparatuses, each of which comprising an encryption key generation part that generates an encryption key in multi-key fully homomorphic encryption, a decryption key generation part that generates a decryption key in the multi-key fully homomorphic encryption, an evaluation key generation part that generates an evaluation key in the multi-key fully homomorphic encryption, a re-encryption key generation part that generates the re-encryption key, an encryption key storage part that stores the encryption key, and a decryption key storage part that stores the decryption key; a plurality of encryption apparatuses, each of which comprising a ciphertext generation part that generates a ciphertext using the encryption key in the multi-key fully homomorphic encryption; an encrypted data operation apparatus comprising a ciphertext storage part that stores a ciphertext, an evaluation key storage part that stores an evaluation key used for an operation between the ciphertexts, and an operation part that performs a homomorphic operation on the ciphertexts; and a decryption apparatus that decrypts the ciphertext encrypted with the different encryption key connected to each other by a network.

According to a third aspect of the present invention, there is provided a distributed re-encryption method including: acquiring shares obtained by secret-sharing a re-encryption key that re-encrypts a ciphertext into one encrypted with a different encryption key without decrypting the ciphertext; and re-encrypting using the shares of the re-encryption key the ciphertext into one encrypted with a different encryption key without decrypting the ciphertext.

According to a fourth aspect of the present invention, there is provided a distributed re-encryption program causing an information processing apparatus to execute: acquiring shares obtained by secret-sharing a re-encryption key that re-encrypts a ciphertext into one encrypted with a different encryption key without decrypting the ciphertext; and re-encrypting using the shares of the re-encryption key the ciphertext into one encrypted with a different encryption key without decrypting the ciphertext.

Further, this program can be stored in a computer-readable storage medium. The storage medium may be a non-transitory one such as a semiconductor memory, a hard disk, a magnetic recording medium, an optical recording medium, and the like. The present invention can also be realized as a computer program product.

According to each aspect of the present invention, be provided a distributed re-encryption there can apparatus, cryptographic system, distributed re-encryption method, and distributed re-encryption program that contribute to preventing the leakage of a user's decryption key from a re-encryption key that re-encrypts a ciphertext so that it can be decrypted with a receiver's key.

### BRIEF DESCRIPTION OF DRAWINGS

FIG. 1 is a drawing illustrating an example of a cryptographic system relating to the present disclosure.

FIG. 2 is a flowchart showing an example of the procedure of a distributed re-encryption method relating to the present disclosure.

FIG. 3 is a drawing illustrating an example of the hardware configuration of a distributed re-encryption apparatus.

### EXAMPLE EMBODIMENTS

An example embodiment of the present invention will be described with reference to the drawings. The present invention, however, is not limited to the example embodiment described below. Further, in each drawing, the same or corresponding elements are appropriately designated by the same reference signs. It should be noted that the drawings are schematic, and the dimensional relationships and the ratios between the elements may differ from the actual ones. The dimensional relationships and the ratios between the drawings may also be different in some sections.

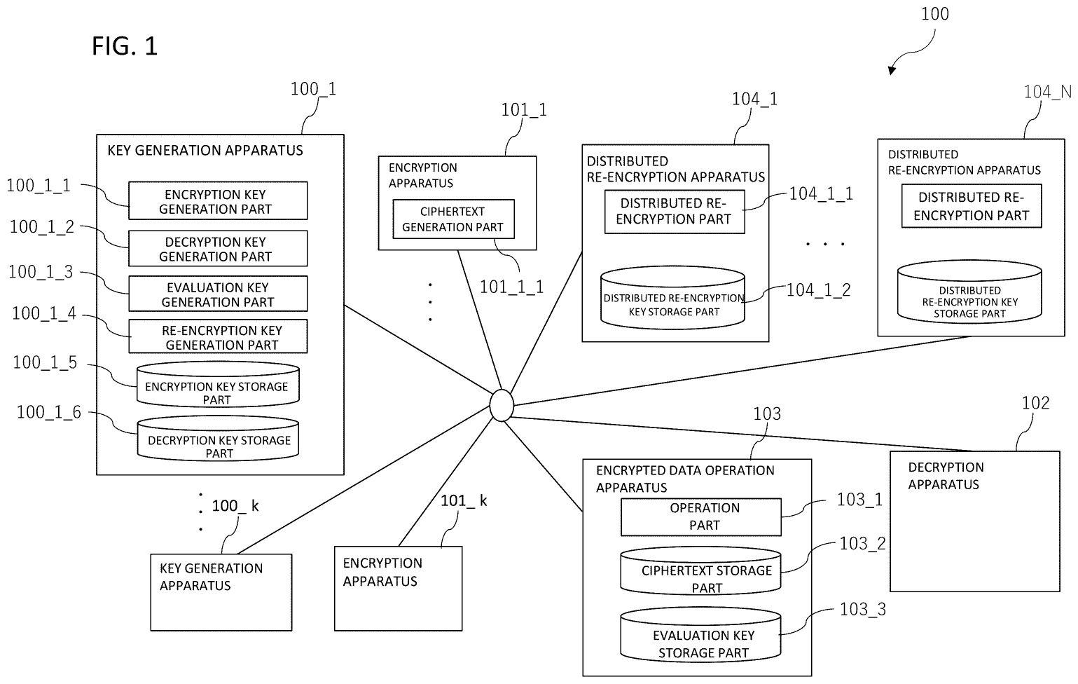

FIG. 1 is a drawing illustrating an example of a cryptographic system relating to the present disclosure. As shown in FIG. 1, the cryptographic system 100 comprises a plurality of key generation apparatuses 100_1, . . . , 100_k, a plurality of encryption apparatuses 101_1, . . . , 101_k, a decryption apparatus 102, an encrypted data operation apparatus 103, a plurality of distributed re-encryption apparatuses 104_1, . . . , 104_N, which are connected to each other by a network. Here, k units of the key generation apparatuses 100_1, . . . , 100_k and the encryption apparatuses 101_1, . . . , 101_k are provided, and k is the number of ciphertexts involved in the multi-key fully homomorphic encryption executed by the encrypted data operation apparatus 103. Note that k is preferably two or greater in terms of application, however, even in a case where k=1, the present invention can be appropriately implemented for the purpose of re-encrypting a ciphertext into one encrypted with an encryption key different from the one used for encryption, and the effects thereof can be obtained. Meanwhile, the number of the distributed re-encryption apparatuses 104_1, . . . , 104_N should be a quantity that can execute secure computation in a secret sharing scheme and should be at least two. As illustrated later, the secure computation in a secret sharing scheme is a computation technique that divides the computation target into small fragments called shares, and distributes the shares across a plurality of apparatuses that hold them. Further, the intended computation can be executed without reconstructing the shares distributed and held separately in the middle of secret computation. One cannot reconstruct the original computation target with just one of the shares distributed and held separately; therefore, security against information leakage is enhanced.

The key generation apparatus 100_1 comprises an encryption key generation part 100_1_1 that generates an encryption key in multi-key fully homomorphic encryption, a decryption key generation part 100_1_2 that generates a decryption key in the multi-key fully homomorphic encryption, an evaluation key generation part 100_1_3 that generates an evaluation key in the multi-key fully homomorphic encryption, a re-encryption key generation part 100_1_4 that generates a re-encryption key, an encryption key storage part 100_1_5 that stores the encryption key, and a decryption key storage part 100_1_6 that stores the decryption key. Note that, although not shown in the drawing, the plurality of key generation apparatuses 100_1, . . . , 100_k all have the same configuration as that of the key generation apparatus 100_1.

The encryption apparatus 101_1 comprise a ciphertext generation part 101_1_1 that generates a ciphertext using the encryption key in the multi-key fully homomorphic encryption. Here, when generating a ciphertext, the ciphertext generation part 101_1_1 receives an encryption key stored in the encryption key storage part 100_1_5 of the key generation apparatus 100_1 and generates the ciphertext utilizing this encryption key. Therefore, the encryption apparatus 101_1 is paired with the key generation apparatus 100_1. Note that, although not shown in the drawing, the plurality of encryption apparatuses 101_1, . . . , 101_k all have the same configuration as that of the encryption apparatus 101_1.

The encrypted data operation apparatus 103 comprises a ciphertext storage part 103_2 that stores a ciphertext, an evaluation key storage part 103_3 that stores an evaluation key used for an operation between the ciphertexts, and an operation part 103_1 that performs a homomorphic operation on the ciphertexts. The ciphertext storage part 103_2 stores the ciphertexts generated by the plurality of encryption apparatuses 101_1, . . . , 101_k, and the evaluation key storage part 103_3 stores the evaluation keys generated by the plurality of key generation apparatuses 100_1, . . . , 100_k. Further, the ciphertexts generated by the plurality of encryption apparatuses 101_1, . . . , 101_k are encrypted using different encryption keys, and the operation part 103_1 takes advantage of the mechanism of multi-key fully homomorphic encryption to execute a homomorphic operation on the ciphertexts encrypted using different encryption keys.

The distributed re-encryption apparatus 104_1 comprises a distributed re-encryption key storage part 104_1_2 that stores shares obtained by secret-sharing a re-encryption key that re-encrypts a ciphertext into one encrypted with a different encryption key without decrypting the ciphertext, and a distributed re-encryption part 104_1_1 that re-encrypts using the shares of the re-encryption key the ciphertext into one encrypted with a different encryption key without decrypting the ciphertext. The distributed re-encryption key storage part 104_1_2 stores shares obtained by secret-sharing the re-encryption keys generated by the plurality of key generation apparatuses 100_1, . . . , 100_k. Note that, although not shown in the drawing, the plurality of distributed re-encryption apparatuses 104_1, . . . , 104_N all have the same configuration as that of the distributed re-encryption apparatus 104_1.

A re-encryption key is configured by combining part of a decryption key for the ciphertext encrypted with the different encryption key and a decryption key for the original ciphertext. Since the distributed re-encryption key storage part 104_1_2 stores the shares obtained by secret-sharing the re-encryption key rather than the re-encryption key proper, the re-encryption key itself will not leak and nor will the decryption key for the original ciphertext even if a secret share of the re-encryption key is leaked from the distributed re-encryption key storage part 104_1_2. Further, since the distributed re-encryption part 104_1_1 executes computation within the scope of secure computation in a secret sharing scheme when re-encrypting using the shares of the re-encryption key a ciphertext into one encrypted with a different encryption key without decrypting the ciphertext, the decryption key for the original ciphertext will not leak even if data is leaked during the re-encryption process. In addition, since the re-encrypted ciphertext is obtained in the form of secret shares, decrypting these shares yields the re-encrypted ciphertext.

The decryption apparatus 102 decrypts ciphertexts re-encrypted by the plurality of distributed re-encryption apparatuses 104_1, . . . , 104_N. Since the plurality of distributed re-encryption apparatuses 104_1, . . . , 104_N re-encrypt ciphertexts into ones decryptable with decryption keys owned by the decryption apparatus 102, the decryption apparatus 102 is able to decrypt ciphertexts using the decryption keys owned thereby.

### Example Using MK-BFV

The following describes an example of the present invention using multi-key BFV (Brakerski/Fan-Vercauteren) as an example of multi-key fully homomorphic encryption. It should be noted that, while an example using multi-key BFV is explained here, this is for illustrating the technical features of the present invention, and that the implementation of the present invention is not limited to the utilization of multi-key BFV.

### [Notation]

A set of users of multi-key BFV is denoted as follows. Note that Uᵢ denotes the i-th user, each of which operates the plurality of key generation apparatuses 100_1, . . . , 100_k and the plurality of encryption apparatuses 101_1, . . . , 101_k in the description above.

$$𝒰 = \{ {U}_{i} \} \qquad [ Math . 1 ]$$

Further, a set of proxy servers is denoted as follows. Note that Pⱼ denotes the j-th proxy server and a set of proxy servers correspond to the plurality of distributed re-encryption apparatuses 104_1, . . . , 104_N in the description above.

$$𝒫 = {\{ {P}_{j} \}}_{j = 0}^{n - 1} \qquad [ Math . 2 ]$$

The algebraic structure used by ciphertext and plaintext is as follows. When q is an integer, R_{q}=R/(q·R), where Rₜ is the plaintext space and each element of the ciphertext belongs to R_{q}.

$$R = ℤ [ X ] / ( {X}^{n} + 1 ) \qquad [ Math . 3 ]$$

As the secret sharing scheme, n-out-of-n additive secret sharing is used. In other words, shares [x] of x are defined as follows. Note that, although the n-out-of-n additive secret sharing scheme is used here, the more general t-out-of-n replicated secret sharing scheme may also be used.

$$[ x ] = ( {[ x ]}_{0} , … , {[ x ]}_{n - 1} ) \qquad [ Math . 4 ]$$

Here, x=x₀+ . . . +xₙ₋₁. (An operation over R_{q}. xᵢ∈R_{q}.)
The share of Pᵢ regarding [x]: [x]ᵢ=xᵢ

Constant addition, constant multiplication, and addition of shares in the n-out-of-n additive secret sharing scheme are defined as follows:

### [Math. 5]

Constant addition: [c+x]=c+[x]
   A clear value (c∈R_{q}), known to [symbol] .
   Calculation method:

$${[ c + x ]}_{i} = \{ \begin{matrix}{[ x ]}_{i} & ( i \neq 0 ) \\ c + {[ x ]}_{i} & ( i = 0 )\end{matrix}$$

set locally for i=0, . . . , n−1.
Constant multiplication: [c·x]=c·[x]
   A clear value (c∈R_{q}), known to [symbol] .
   Calculation method: [c·x]ᵢ=c·[x]ᵢ set locally for i=0, . . . , n−1.
Addition of shares: [x₀+x₁]=[x₀]+[x₁]
   Calculation method: [x₀+x₁]ᵢ=[x₀]ᵢ+[x₁]ᵢ set locally for i=0, . . . , n−1.

### [Note on Multi-Key BFV]

In the normal BFV, the ciphertext is as shown below, but it becomes an extended ciphertext in a homomorphic operation. That is, for a ciphertext involving a user set T={id₁, . . . , idₖ}, the number of ciphertext headers increases as follows. When homomorphic operations are performed on ciphertexts involving different user sets T and T′, for instance, zero padding is performed, aligning the size to the larger of |T| and |T′|.

$$\begin{matrix}\overline{ct} = ( {c}_{0} , {c}_{1} ) s . t . {c}_{i} ∈ {R}_{q} \\ {\overline{ct}}_{T}^{*} = ( {c}_{0} , {c}_{i {d}_{1}} , … , {c}_{{id}_{k}} )\end{matrix} \qquad [ Math . 6 ]$$

When the secret key of each participant i is sᵢ∈R₃ and the user set T={id₁, . . . , idₖ}, the extended ciphertext is decrypted as follows. In practice, the participants decrypt it by partially decrypting each element and then merging the results.

$$\begin{matrix}\overline{ct} = {\overline{ct}}_{T}^{*} = ( {c}_{0} , {c}_{1} , … , {c}_{k} ) ∈ {R}_{q}^{k + 1} \\ \overline{sk} = ( 1 , {s}_{1} , … , {s}_{k} ) ∈ {R}_{3}^{k + 1}\end{matrix} \qquad [ Math . 7 ]$$

### [Syntax]

### [Math. 8]

1. param←Setup(1^{λ}, 1^{k})
   1^{λ}: security parameter; 1^{k}: the total number of users;
   param: public parameter
2. (pkᵢ, skᵢ)←KeyGen(param, Uᵢ)
   (pkᵢ, skᵢ): the public key pkᵢ of user Uᵢ; secret key skᵢ
3. c_{{U}_{ᵢ}_{}}←Enc(param, pkᵢ, m)
   m: plaintext; c_{{U}_{ᵢ}_{}}: ciphertext (level 0) encrypted with the public key of user Uᵢ
4. ĉ_{0,T″}, ĉ_{1,T″}←Extend(param, c_{0, T}, c_{1, T′})
   c_{0, T}: ciphertext encrypted with the public key of a user
   belonging to the user set T.
   c_{1, T′}: ciphertext encrypted with the public key of a user
   belonging to the user set T′
   ĉ_{0,T″}: what is obtained by extending c_{0, T} to a ciphertext
   encrypted with the public key of a user belonging to a user
   set T″=T∪T′
   ĉ_{1,T″}: what is obtained by extending c_{1, T′} to a ciphertext
   encrypted with the public key of a user belonging to the user
   set T″
5. EK_{T″}←EvalKeyGen(param, {pkᵢ}_{T″})
   EK_{T″}: the evaluation key relating to the user set T″
6. [symbol] ←Eval(ĉ_{0,T″}, ĉ_{1,T″}, EK_{T″}, op.)
   [symbol] : the resulting ciphertext after an operation
   op.: operation
7. [rk_{i→j}]←RKGen((Uᵢ, skᵢ), (Uⱼ,rⱼ))
   rⱼ: masking random number
   [rk_{i→j}]: a share of the re-encryption key from Uᵢ to Uⱼ
8. [ [symbol] ]←MPReEnc({[rk_{i→j}]}_{i∈T}, [symbol] )
   [ [symbol] ]: a share of the re-encrypted ciphertext
9. m←Dec1( [symbol] , {skᵢ}_{T})
   *decryption in the normal MK-BFV
10. m←Dec2([ [symbol] ], {rⱼ})

### [Re-Encryption Key Generation]

A decryptor Uⱼ generates a random number r_{(i→j)}∈R_{q} that will later become part of the decryption key and sends it to the user Uᵢ (i=1, . . . ). While it is assumed here that the re-encryption keys are generated for all the users, in a case where the re-encryption keys are generated only for a user subset U′⊂U, the random number may be sent to each user included in U′. Further, since the random number r_{(i→j)} is not a public key, it is sent in such a way that only the user Uᵢ and the decryptor Uⱼ know it.

Each user Uᵢ computes the re-encryption key rk_{(i→j)}=sᵢ−r_{(i→j)}(mod q) and sends [rk_{(i→j)}] as a secret share to the proxy server group. Note that sᵢ∈R₃ is the secret key (decryption key) of the user Uᵢ. As described, since the re-encryption key rk_{(i→j)}=sᵢ−r_{(i→j)}(mod q) includes the decryption key sᵢ of the user Uᵢ and a part r_{(i→j)} of the decryption key of the decryptor Uⱼ, leaking the re-encryption key rk_{(i→j)} will result in the leakage of the decryption key sᵢ of the user Uᵢ and a part r_{(i→j)} of the decryption key of the decryptor Uⱼ. In the present configuration, however, the shares [rk_{(i→j)}] of the re-encryption key rk_{(i→j)}, instead of the re-encryption key rk_{(i→j)}, are sent to the proxy server group. Even if a share [rk_{(i→j)}] leaks, it alone does not lead to the leakage of the user Uᵢ's decryption key sᵢ or the leakage of the part r_{(i→j)} of the decryption key of the decryptor Uⱼ. Therefore, high security is ensured.

### [Re-Encryption and Decryption]

Let us consider re-encryption on the extended MK-BFV ciphertext so that the decryptor Uⱼ can decrypt it without communicating with other users. Here, the proxy server group shares [rk_{(id1→j)}], . . . , [rk_{(idk→j)}] and the MK-BFV ciphertext.

### [Math. 9]

MK-BFV ciphertext c̅t*_{T}=(c₀, c_{id}_{₁}, . . . , c_{id}_{ₖ})

$$\begin{matrix}{c}_{0} = \frac{q}{t} m + {e}_{0} + {\sum }_{i = 1}^{k} {v}_{i} {b}_{i} where {b}_{i} = - {s}_{i} \cdot {a}_{i} + {e}_{i}^{′} \\ {c}_{i} = {v}_{i} \cdot {a}_{i} + {e}_{i}\end{matrix}$$

The proxy server group performs the computation below:

$$[ {c}_{0}^{′} ] = {c}_{0} + {\sum }_{{i}^{′} = 1}^{k} {c}_{{id}_{i}^{′}} \cdot [ {rk}_{{id}_{i}^{′} \to j} ] = [ \frac{q}{t} m + {e}_{0} + {\sum }_{i = 1}^{k} ( {v}_{i} {e}_{i}^{′} + {s}_{i} {e}_{i} ) - {\sum }_{{i}^{′} = 1}^{k} {c}_{{id}_{i}^{′}} \cdot {r}_{{id}_{i}^{′} \to j} ] \qquad [ Math . 10 ]$$

Then, the proxy server group reconstructs the value above after adding smudging noise and sends c₀′ to the decryptor Uⱼ. Note that smudging noise may be added by a computation server in a supportive manner. Further, the proxy server group sends (c_{id1}, . . . , c_{idk}) to the decryptor Uj.

Then, the decryptor Uⱼ computes the following using the re-encrypted ciphertext (c₀′, c_{id1}, . . . , c_{idk}) and a random number {r_{(idi′→j)}}^{k}_{i′=1} functioning as the decryption key:

$$\begin{matrix}μ = \frac{q}{t} m + {e}_{0} + {\sum }_{i = 1}^{k} ( {v}_{i} {e}_{i}^{′} + {s}_{i} {e}_{i} ) = {c}_{0}^{′} + {\sum }_{{i}^{′} = 1}^{k} {c}_{{id}_{i}^{′}} \cdot {r}_{{id}_{i}^{′} \to j} \\ m = ⌊ \frac{t}{q} \cdot μ ⌉ mod t\end{matrix} \qquad [ Math . 11 ]$$

At this time, note that the following terms can be ignored if error noises e₀, eᵢ′, eᵢ are sufficiently small. As a result, the correct plaintext m (mod t) is obtained.

### (Distributed Re-Encryption Method)

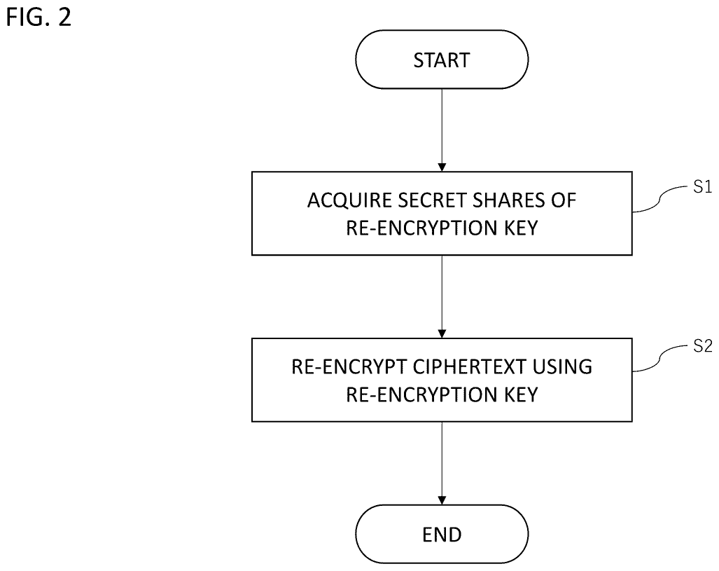

FIG. 2 is a flowchart showing an example of the procedure of a distributed re-encryption method relating to the present disclosure. As shown in FIG. 2, the distributed re-encryption method has a process of acquiring shares obtained by secret-sharing a re-encryption key (step S1) and a process of re-encrypting a ciphertext using the re-encryption key (step S2). Note that it is assumed that these processes are executed by the plurality of distributed re-encryption apparatuses 104_1, . . . , 104_N.

The process of acquiring shares obtained by secret-sharing a re-encryption key (the step S1) acquires secret shares of a re-encryption key that re-encrypts a ciphertext into one encrypted with a different encryption key without decrypting the ciphertext, and this re-encryption key is obtained by receiving re-encryption keys generated by the re-encryption key generation parts 100_1_4, . . . 100_1_k of the key generation apparatuses 100_1, . . . , 100_k.

The process of re-encrypting the ciphertext using the re-encryption key (the step S2) re-encrypts using the shares of the re-encryption key the ciphertext into one encrypted with a different encryption key without decrypting the ciphertext. This re-encryption process is secure computation in a secret sharing scheme using the shares of the re-encryption key. In other words, as stated above, the decryption key for the original ciphertext will not leak even if data is leaked during the re-encryption process.

### Hardware Configuration Example

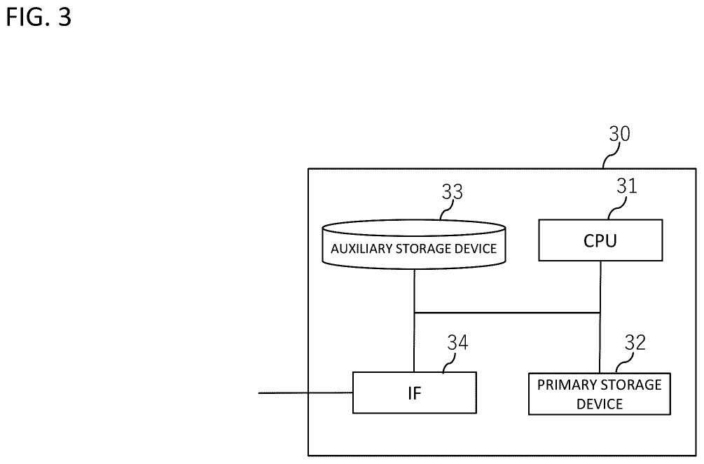

FIG. 3 is a drawing illustrating an example of the hardware configuration of the distributed re-encryption apparatus. In other words, the plurality of distributed re-encryption apparatuses 104_1, . . . , 104_N can achieve the functions thereof by causing an information processing apparatus (computer) 30 employing the hardware configuration shown in FIG. 3 to execute the distributed re-encryption method described above as a program. It should be noted that the hardware configuration example shown in FIG. 3 is merely an example of the hardware configuration that achieves the functions of the plurality of distributed re-encryption apparatuses 104_1, . . . , 104_N, and is not intended to limit the hardware configuration of the plurality of distributed re-encryption apparatuses 104_1, . . . , 104_N. The plurality of distributed re-encryption apparatuses 104_1, . . . , 104_N may include hardware not shown in FIG. 3.

As shown in FIG. 3, the hardware configuration that may be employed by the plurality of distributed re-encryption apparatuses 104_1, . . . , 104_N comprises a CPU (Central Processing Unit) 31, a primary storage device 32, an auxiliary storage device 33, and an IF (interface) part 34, which are connected to each other by, for instance, an internal bus.

The CPU 31 executes each instruction included in the distributed re-encryption program executed by the information processing apparatus (computer) 30. The primary storage device 32 is, for instance, a RAM (Random Access Memory) and temporarily stores various programs such as the distributed re-encryption program executed by the information processing apparatus (computer) 30 so that the CPU 31 can process the programs.

The auxiliary storage device 33 is, for instance, an HDD (Hard Disk Drive) and is capable of storing the various programs, such as the distributed re-encryption program executed by the information processing apparatus (computer) 30, in the medium to long term. The various programs such as the distributed re-encryption program may be provided as a program product recorded in a non-transitory computer-readable storage medium.

The IF part 34 provides an interface to the input and output of the plurality of distributed re-encryption apparatuses 104_1, . . . , 104_N, for instance.

The information processing apparatus (computer) 30 employing the hardware configuration described above achieves the functions of the plurality of distributed re-encryption apparatuses 104_1, . . . , 104_N by executing the distributed re-encryption method described above as a program.

Part or all of the example embodiments above can be described as (but not limited to) the following Supplementary Notes.

### [Supplementary Note 1]

A distributed re-encryption apparatus comprising:
a distributed re-encryption key storage part that stores shares obtained by secret-sharing a re-encryption key that re-encrypts a ciphertext into one encrypted with a different encryption key without decrypting the ciphertext; and
a distributed re-encryption part that re-encrypts using the shares of the re-encryption key the ciphertext into one encrypted with a different encryption key without decrypting the ciphertext.

### [Supplementary Note 2]

The distributed re-encryption apparatus according to Supplementary Note 1, wherein the ciphertext is a result of a homomorphic operation between ciphertexts encrypted with different keys.

### [Supplementary Note 3]

The distributed re-encryption apparatus according to Supplementary Note 1 or 2, wherein the re-encryption key is configured by combining part of a decryption key for the ciphertext encrypted with the different encryption key and a decryption key for the ciphertext.

### [Supplementary Note 4]

The distributed re-encryption apparatus according to any one of Supplementary Notes 1 to 3, wherein the ciphertext encrypted with the different encryption key is obtained by decrypting what are computed as secret shares.

### [Supplementary Note 5]

A cryptographic system having:
a plurality of the distributed re-encryption apparatuses according to any one of Supplementary Notes 1 to 4;
a plurality of key generation apparatuses, each of which comprising an encryption key generation part that generates an encryption key in multi-key fully homomorphic encryption, a decryption key generation part that generates a decryption key in the multi-key fully homomorphic encryption, an evaluation key generation part that generates an evaluation key in the multi-key fully homomorphic encryption, a re-encryption key generation part that generates the re-encryption key, an encryption key storage part that stores the encryption key, and a decryption key storage part that stores the decryption key;
a plurality of encryption apparatuses, each of which comprising a ciphertext generation part that generates a ciphertext using the encryption key in the multi-key fully homomorphic encryption;
an encrypted data operation apparatus comprising a ciphertext storage part that stores a ciphertext, an evaluation key storage part that stores an evaluation key used for an operation between the ciphertexts, and an operation part that performs a homomorphic operation on the ciphertexts; and
a decryption apparatus that decrypts the ciphertext encrypted with the different encryption key connected to each other by a network.

### [Supplementary Note 6]

The cryptographic system according to Supplementary Note 5, wherein
the re-encryption key is configured by combining part of a decryption key for the ciphertext encrypted with the different encryption key and a decryption key for the ciphertext.

### [Supplementary Note 7]

A distributed re-encryption method including:
acquiring shares obtained by secret-sharing a re-encryption key that re-encrypts a ciphertext into one encrypted with a different encryption key without decrypting the ciphertext; and
re-encrypting using the shares of the re-encryption key the ciphertext into one encrypted with a different encryption key without decrypting the ciphertext.

### [Supplementary Note 8]

The distributed re-encryption method according to Supplementary Note 7, wherein
the ciphertext encrypted with the different encryption key is obtained by decrypting what are computed as secret shares.

### [Supplementary Note 9]

A distributed re-encryption program causing an information processing apparatus to execute:
acquiring shares obtained by secret-sharing a re-encryption key that re-encrypts a ciphertext into one encrypted with a different encryption key without decrypting the ciphertext; and
re-encrypting using the shares of the re-encryption key the ciphertext into one encrypted with a different encryption key without decrypting the ciphertext.

### [Supplementary Note 10]

The distributed re-encryption program according to Supplementary Note 9 causing an information processing apparatus to execute obtaining the ciphertext encrypted with the different encryption key by decrypting what are computed as secret shares.

Further, the disclosure of Non-Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select (or partially remove) a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any intermediate values or subranges falling within the disclosed ranges are also concretely disclosed even without specific recital thereof. In addition, using some or all of the disclosed elements in each literature cited above as necessary in combination with the elements described herein as part of the disclosure of the present invention in accordance with the object of the present invention shall be considered to be included in the disclosed elements of the present application.

### REFERENCE SIGNS LIST

100: cryptographic system
100_1, . . . , 100_k: key generation apparatus
100_1_1: encryption key generation part
100_1_2: decryption key generation part
100_1_3: evaluation key generation part
100_1_4: re-encryption key generation part
100_1_5: encryption key storage part
100_1_6: decryption key storage part
101_1, . . . , 101_k: encryption apparatus
101_1_1: ciphertext generation part
102: decryption apparatus
103: encrypted data operation apparatus
103_1: operation part
103_2: ciphertext storage part
103_3: evaluation key storage part
104_1, . . . , 104_N: distributed re-encryption apparatus
104_1_1: distributed re-encryption part
104_1_2: distributed re-encryption key storage part
30: information processing apparatus
31: CPU
32: primary storage device
33: auxiliary storage device
34: IF part

What is claimed is:

1. A distributed re-encryption apparatus comprising:
a distributed re-encryption key storage part that stores shares obtained by secret-sharing a re-encryption key that re-encrypts a ciphertext into one encrypted with a different encryption key without decrypting the ciphertext; and
a distributed re-encryption part that re-encrypts using the shares of the re-encryption key the ciphertext into one encrypted with a different encryption key without decrypting the ciphertext.

2. The distributed re-encryption apparatus according to claim 1, wherein the ciphertext is a result of a homomorphic operation between ciphertexts encrypted with different keys.

3. The distributed re-encryption apparatus according to claim 1, wherein the re-encryption key is configured by combining part of a decryption key for the ciphertext encrypted with the different encryption key and a decryption key for the ciphertext.

4. The distributed re-encryption apparatus according to claim 1, wherein the ciphertext encrypted with the different encryption key is obtained by decrypting what are computed as secret shares.

5. A cryptographic system having:
a plurality of the distributed re-encryption apparatuses according to claim 1;
a plurality of key generation apparatuses, each of which comprising an encryption key generation part that generates an encryption key in multi-key fully homomorphic encryption, a decryption key generation part that generates a decryption key in the multi-key fully homomorphic encryption, an evaluation key generation part that generates an evaluation key in the multi-key fully homomorphic encryption, a re-encryption key generation part that generates the re-encryption key, an encryption key storage part that stores the encryption key, and a decryption key storage part that stores the decryption key;
a plurality of encryption apparatuses, each of which comprising a ciphertext generation part that generates a ciphertext using the encryption key in the multi-key fully homomorphic encryption;
an encrypted data operation apparatus comprising a ciphertext storage part that stores a ciphertext, an evaluation key storage part that stores an evaluation key used for an operation between the ciphertexts, and an operation part that performs a homomorphic operation on the ciphertexts; and
a decryption apparatus that decrypts the ciphertext encrypted with the different encryption key,
connected to each other by a network.

6. The cryptographic system according to claim 5, wherein
the re-encryption key is configured by combining part of a decryption key for the ciphertext encrypted with the different encryption key and a decryption key for the ciphertext.

7. The cryptographic system according to claim 5, wherein the ciphertext encrypted with the different encryption key is obtained by decrypting what are computed as secret shares.

8. A distributed re-encryption method including:
acquiring shares obtained by secret-sharing a re-encryption key that re-encrypts a ciphertext into one encrypted with a different encryption key without decrypting the ciphertext; and
re-encrypting using the shares of the re-encryption key the ciphertext into one encrypted with a different encryption key without decrypting the ciphertext.

9. The distributed re-encryption method according to claim 8, wherein the ciphertext is a result of a homomorphic operation between ciphertexts encrypted with different keys.

10. The distributed re-encryption method according to claim 8, wherein
the re-encryption key is configured by combining part of a decryption key for the ciphertext encrypted with the different encryption key and a decryption key for the ciphertext.

11. The distributed re-encryption method according to claim 8, wherein
the ciphertext encrypted with the different encryption key is obtained by decrypting what are computed as secret shares.

12. A non-transitory computer readable medium storing a distributed re-encryption program causing an information processing apparatus to execute:
acquiring shares obtained by secret-sharing a re-encryption key that re-encrypts a ciphertext into one encrypted with a different encryption key without decrypting the ciphertext; and
re-encrypting using the shares of the re-encryption key the ciphertext into one encrypted with a different encryption key without decrypting the ciphertext.

13. The non-transitory computer readable medium storing the distributed re-encryption program according to claim 12 wherein the ciphertext is a result of a homomorphic operation between ciphertexts encrypted with different keys.

14. The non-transitory computer readable medium storing the distributed re-encryption program according to claim 12 causing an information processing apparatus to execute obtaining the ciphertext encrypted with the different encryption key by decrypting what are computed as secret shares.

15. The non-transitory computer readable medium storing the distributed re-encryption program according to claim 12 wherein
the re-encryption key is configured by combining part of a decryption key for the ciphertext encrypted with the different encryption key and a decryption key for the ciphertext.
